(19) United States
(12) Patent Application Publication
(10) Pub. No.: US 2007/0274545 A1
(43) Pub. Date: Nov. 29, 2007

(54) ELECTROSTATIC SPEAKER

(75) Inventors: Takao Nakaya, Shizuoka-ken (JP); Yasuaki Takano, Shizuoka-ken (JP); Takashi Yamakawa, Shizuoka-ken (JP)

Correspondence Address: HARNESS, DICKEY & PIERCE, P.L.C., P.O. BOX 828, BLOOMFIELD HILLS, MI, 48303, US

(73) Assignee: YAMAHA CORPORATION, Shizuoka-ken (JP)

(21) Appl. No.: 11/752,589

(22) Filed: May 23, 2007

(30) Foreign Application Priority Data
May 24, 2006 (JP) 2006-144384

(51) Int. Cl. H04R 25/00

(52) U.S. Cl. 381/191

(57) ABSTRACT

An electrostatic speaker capable of relaxing a restriction on the allowable amplitude of a diaphragm while maintaining the linearity of a force acting on the diaphragm. The electrostatic speaker mainly includes electrodes opposed to each other, a diaphragm, and elastic members interposed between the diaphragm and the electrodes. The elastic members have an elastic characteristic that generates a restorative force corresponding to higher order terms of an electrostatic force generated by the electrodes and acting on the diaphragm.

### BACKGROUND OF THE INVENTION

1. Field of the Invention

The present invention relates to the construction of an electrostatic speaker.

2. Description of the Related Art

There is known a speaker that is called an electrostatic speaker (capacitor speaker). Since the electrostatic speaker is relatively simple in construction, attention has been paid to the points that the electrostatic speaker can be designed to be light in weight and compact in size and easily handled theoretically and so forth. Typically, the electrostatic speaker is comprised of two parallel flat electrodes facing each other with a gap therebetween and an electrically conductive sheet member (hereinafter referred to as the diaphragm or the vibrating membrane) inserted between the electrodes and having both ends thereof fixed to a chassis of the speaker (i.e., the typical electrostatic speaker is of a push-pull type). When a predetermined bias voltage is applied to the diaphragm to change the voltage applied across the electrodes, an electrostatic force applied to the diaphragm changes, whereby the diaphragm is displaced. Since the diaphragm is ordinarily fixed at a verge or edge thereof to the chassis, the displacement of the diaphragm becomes greater at a central part thereof, so that the diaphragm is deformed as a whole. When the voltage applied across the electrodes is caused to change according to an input musical tone signal, the diaphragm is displaced repeatedly or vibrates, so that an acoustic wave varying according to the input musical tone signal is generated from the diaphragm. The generated musical tone passes through a hole or the like formed in one of the electrodes, which are such as metal plate electrodes, and is sounded to the outside of the speaker (See, Naraji Sakamoto, “Speakers and Speaker Systems”, The Daily Industrial News).

As a result, the diaphragm is applied with an electrostatic force generated by the input signal and an elastic stress (a restorative force) caused by the displacement of the diaphragm. Due to characteristics of these two forces, an allowable amplitude of the diaphragm is limited as will be described below, which causes a problem.

FIG. 6 is a view schematically shows a cross section of a typical push-pull type electrostatic speaker 100. For convenience of explanation, there are only shown flat opposed electrodes 101, 102 and a diaphragm 103, which are primary elements of the speaker. In FIG. 6, an X axis is taken in the direction perpendicular to opposed surfaces of the electrodes 101, 102 and a surface of the diaphragm 103. It is assumed that the diaphragm 103 is located at a position of x=0 exactly intermediate between the electrodes when there is no input signal. In this state, the distance from the diaphragm 103 to each electrode is equal to d, and an electrostatic force acting on the diaphragm 103 in the positive x direction is balanced with that acting thereon in the negative x direction. Thus, the displacement of the diaphragm remains zero with no elastic stress acting thereon.

When a voltage corresponding to an inputted musical tone signal is applied across the electrodes 101, 102 and an electrostatic force corresponding to the musical tone signal is applied to the diaphragm 103, the diaphragm 103 is attracted toward either one of the electrodes 101, 102. If, as a result, the diaphragm 103 (more accurately, a central part thereof) is displaced to a position x, then an electro static force Fₘ acting on the diaphragm at that position is represented by the following equation (1), where B is a positive constant.

Fₘ=B/(d−x)²−B/(d+x)² (1)

By expanding the equation (1) into power series, we obtain the following equation (2).

Fₘ=B(4x/d³+8x³/d⁵+ - - - ) (2)

As described above, an elastic stress acts on the diaphragm 103 when the diaphragm is displaced. The elastic stress Fₛ acting on the diaphragm 103 located at a position x (i.e., when the displacement of the diaphragm is equal to x) is generally represented by the following equation (3), where A (positive constant) represents the elastic coefficient that is uniquely determined by the material and structure of the diaphragm.

Fₛ=−Ax (3)

Thus, the force Fₜₒₜₐₗ acting on the diaphragm 103 is represented by the following equation (4).

Fₜₒₜₐₗ=Fₘ+Fₛ=(−A+4B/d³)x+B(8x³/d⁵+ . . . ) (4)

FIG. 7 shows a relationship between the electrostatic force Fₘ acting on the diaphragm 103 and the elastic stress Fₛ. It should be noted that in FIG. 7 the sign of the elastic stress Fₛ is inverted for comparison between the magnitude of the electrostatic force Fₘ and that of the elastic stress Fₛ. As understood from FIG. 7, when the displacement is larger than x_{c} (i.e., when the amplitude of the diaphragm 103 is as large as 2x_{c}, or more), a relationship of Fₘ>Fₛ is always satisfied, and therefore, the diaphragm 103 is theoretically brought in contact with either one of the electrodes. In some cases, the displacement of the diaphragm 103 can exceed the elastic limit thereof before the diaphragm is in contact with the electrode, so that there is a possibility of the diaphragm 103 being broken.

To obviate this, it is necessary to suppress the amplitude of the diaphragm 103 within a constant range. The reason why the amplitude of the diaphragm must be suppressed will be explained with reference to FIG. 8. FIG. 8 shows the entire force (the sum of the electrostatic force Fₘ and the elastic stress Fₛ) acting on the diaphragm 103 and varying depending on the displacement thereof. As seen from FIG. 8, Fₜₒₜₐₗ has a local maximum at x=±x₂, and the curve of Fₜₒₜₐₗ has a positive slope in regions outside x_{c}, which indicates that the force acting on the diaphragm is exerted in the same direction as that of the displacement of the diaphragm. When the diaphragm 103 is in that region, there occurs the aforesaid problem of the diaphragm contacting with the electrode or being broken. Thus, the diaphragm 103 must be prevented from being displaced outside a range from −x1 to x1. To this end, an upper limit may be set for the input signal power.

Even if the risk of the diaphragm contacting with the electrode or being broken is eliminated, there remains an acoustic characteristic problem. The reason why there is such a problem can easily be understood by considering a time-dependent change of Fₜₒₜₐₗ acting on the diaphragm 103. From the viewpoint of acoustic characteristic, it is ideal that the sum of forces acting on the diaphragm 103 acts as a linear restorative force as shown in FIG. 10. FIG. 10 shows a time-dependent change of the sum of forces acting on the diaphragm that performs an ideal vibration with the amplitude of 2Fₘₐₓ. When a force as shown in FIG. 9 acts on the diaphragm 103, the diaphragm 103 is not in an ideal vibration state and the acoustic characteristic is lowered.

In consideration of the acoustic characteristic, the input signal power is generally limited so that the displacement shown in FIG. 8 is within a rage from −x₂ to x₂. To further improve the acoustic characteristic, it may be necessary to limit the amplitude of the diaphragm to within a region where a substantially linear relationship is found between displacement and force (within a range from −X₃ to X₃ in FIG. 8) in order to cause the diaphragm to approach the ideal vibration state.

It is apparent that the larger the distance between the electrodes is, the broader the allowable range of the amplitude of the diaphragm 10 with regard to the aforesaid contacting problem. However, in that case, there occur problems that the electrostatic force acting on the diaphragm decreases to thereby lower the output sound pressure and the voltage to be applied across the electrodes must be large enough to secure a predetermined output sound pressure. Thus, it is difficult for the prior art electrostatic speaker to have both the expanded amplitude (the expanded allowable displacement range) of the diaphragm and the linearity of the force acting on the diaphragm, which prevents the electrostatic speaker from being improved in performance.

### SUMMARY OF THE INVENTION

The present invention provides an electrostatic speaker capable of relaxing a restriction on diaphragm's allowable amplitude while maintaining the linearity of a force acting on the diaphragm of the speaker.

According to the present invention, there is provided an electrostatic speaker comprising a pair of opposed electrodes, a diaphragm disposed between the opposed electrodes so as to be able to be displaced by an elastic force, and elastic members having a linear elastic characteristic that generates a restorative force proportional to a cube power of a strain in a direction in which the diaphragm is displaced, the elastic members being interposed between said diaphragm and respective ones of the opposed electrodes.

According to the present invention, a restorative force that cancels a third order strain is exerted from the interposed elastic members onto the diaphragm, and as a result, the linearity of the force acting on the diaphragm is kept maintained, even if the amplitude (allowable displacement range) of the diaphragm increases.

The linear elastic characteristic can further include a contribution that is proportional to a first power of the strain.

In a case where a distance between the diaphragm in a non-displaced state and one of the opposed electrodes is represented by d, the displacement of the diaphragm is represented by x, B is a positive constant, and an electrostatic force Fₘ acting on the diaphragm is represented by an equation of Fₘ=B(1/(d−x)²)−B(1/(d+x)²), then the restorative force Fₛ represented by an equation of Fₛ=−Bx³/d⁵ can be generated.

The elastic members can each be fixed in a state applied with a predetermined preload so as to realize the linear elastic characteristic.

Further features of the present invention will become apparent from the following description of an exemplary embodiment with reference to the attached drawings.

### BRIEF DESCRIPTION OF THE DRAWINGS

FIG. 1 is a view showing the external structure of an electrostatic speaker according to an embodiment of the present invention;

FIG. 2 is a graph showing a force acting on a diaphragm of the electrostatic speaker;

FIG. 3 is a graph showing a force acting on the diaphragm of the electrostatic speaker;

FIG. 4 is a graph showing a force acting on the diaphragm of the electrostatic speaker;

FIG. 5 is a graph showing a strain-stress characteristic of an elastic member;

FIG. 6 is a view showing the external construction of a prior art electrostatic speaker;

FIG. 7 is a graph showing a force acting on a diaphragm of the electrostatic speaker;

FIG. 8 is a graph showing a force acting on the diaphragm of the electrostatic speaker;

FIG. 9 is a graph showing a force acting on the diaphragm of the electrostatic speaker; and

FIG. 10 is a graph showing a force acting on the diaphragm of the electrostatic speaker 100.

### DETAILED DESCRIPTION OF THE PREFERRED EMBODIMENT

In the following, a preferred embodiment of the present invention will be described with reference to the drawings.

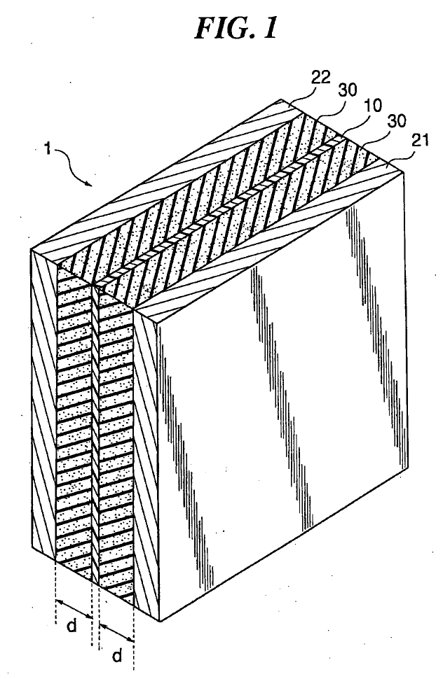

FIG. 1 is a perspective view schematically showing the construction of an electrostatic speaker 1 according to one embodiment of the present invention. As shown in FIG. 1, the electrostatic speaker 1 is comprised of a diaphragm 10, two flat electrodes (hereinafter simply referred to as the electrodes) 21, 22 facing the diaphragm, and elastic members 30 each disposed in a space defined between the diaphragm 10 and a corresponding one of the electrodes 21, 22.

The diaphragm 10 is formed, for example, by an electrically conductive plate-like (film-like) member having a thickness thereof varying from several microns to several ten microns. Specifically, the electrically conductive member is formed, such as for example, by a film of PET (polyethylene terephthalate) or PP (polypropylene) on which a metal film is deposited or an electrically conductive coating is applied. The diaphragm 10 is supported from both sides by pressures (elastic forces) applied from the elastic members 30. Alternatively, the diaphragm 10 may be fixed at its one side edge to a chassis (not shown) of the electrostatic speaker 1, with a predetermined tensile force applied to the diaphragm 10, using fixing means (not shown) which is formed by an insulating material such as vinyl chloride, acryl(methyl methacrylate), rubber, or the like.

The electrodes 21, 22 are made of a material, such as a punching metal which is a metal plate formed with holes (not shown), a sputtered nonwoven fabric, or a fabric applied with electrically conductive coating, each of which is electrically conductive and highly transparent to sound waves. The electrodes are fixed to the chassis (not shown) of the electrostatic speaker 1. The diaphragm 10 is disposed so that the distances d between the diaphragm 10 and the electrodes are equal to each other. In other words, the diaphragm 10 (more accurately, the diaphragm 10 which is in a non-displaced state where there is no input signal) is disposed at a position exactly intermediate between the electrodes facing the diaphragm.

The electrostatic speaker 1 includes a power source, not shown, and is adapted to apply to the electrodes 21, 22 voltages opposite in polarity to each other and apply a bias voltage to the diaphragm (vibrating membrane) 10. The electrostatic speaker 1 further includes an input unit that receives an audio signal from the outside, and is adapted to cause a value of the applied voltage to change according to the audio signal, thereby causing the diaphragm 10 to vibrate according to the audio signal. A sound wave generated by the vibration of the diaphragm 10 passes through the electrode 21 or 22 and is sounded to the outside of the speaker. It should be noted that the bias voltage may be applied using an electret material, which is comprised of a charged nonwoven fabric or the like.

The elastic members 30 are each comprised of an electrically nonconductive material, such as nonwoven fabric, cotton, or sponge, having a predetermined elastic characteristic and being deformable when applied with an external force. The elastic members 30 have surfaces thereof applied with adhesion layers and are fixed to the electrodes 21, 22 through the adhesion layers. Each elastic member 30 is not limited to a single material elastic member, but may be one having such a composite structure where a plurality of springs are covered by a coating material. When the diaphragm 10 is displaced (vibrated), each elastic member 30 is deformed according to its elastic modulus and exerts a force (restorative force) on the diaphragm 10 in the direction opposite the direction in which the diaphragm is displaced. It should be noted that the below-mentioned elastic characteristic of the elastic members 30 is, in a broad sense, an elastic characteristic that indicates how the elastic members are deformed when applied with an external force exerting in a predetermined direction (in this embodiment, a force applied from the diaphragm 10 and acting in the direction perpendicular to the electrodes 21, 22) and as a result how the elastic members generate a restorative force acting toward the outside. Such elastic characteristic of the elastic members 30 can be defined using a strain-stress curve, a modulus of linear elasticity (Young's modulus) in the thickness direction, and a non-linear elasticity (secant modulus) of the elastic members, and the like. The electrostatic speaker 1 according to this embodiment differs from the prior art electrostatic speaker in that the diaphragm 10 receives a restorative force from the interposed elastic members 30. The present embodiment is characterized by the elastic characteristic of the elastic members 30, which will be described in detail below.

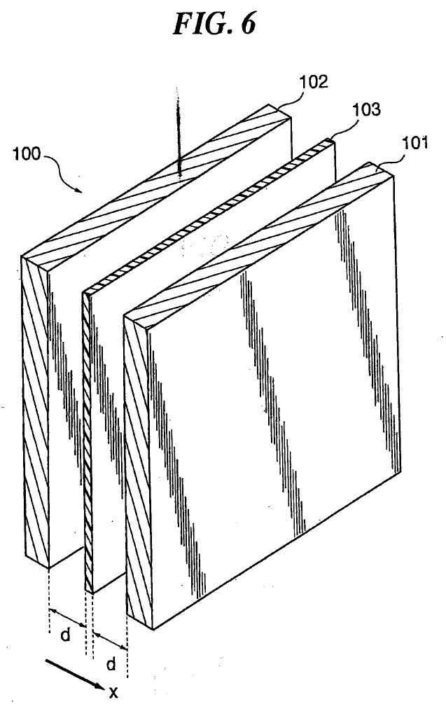

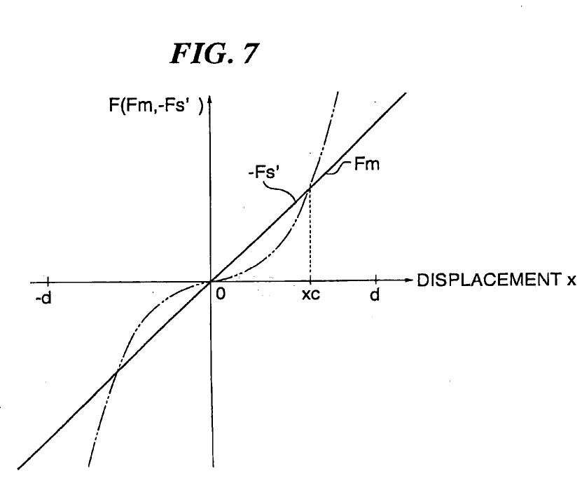

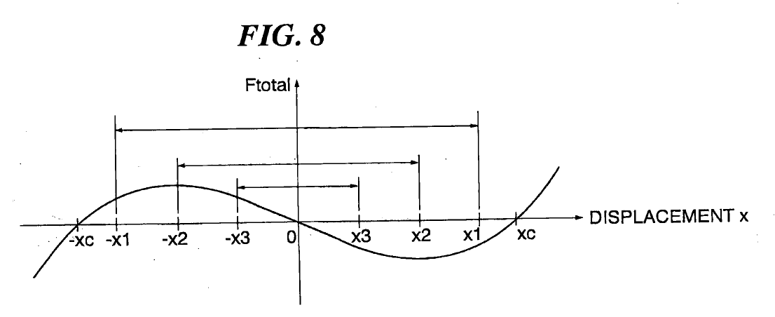

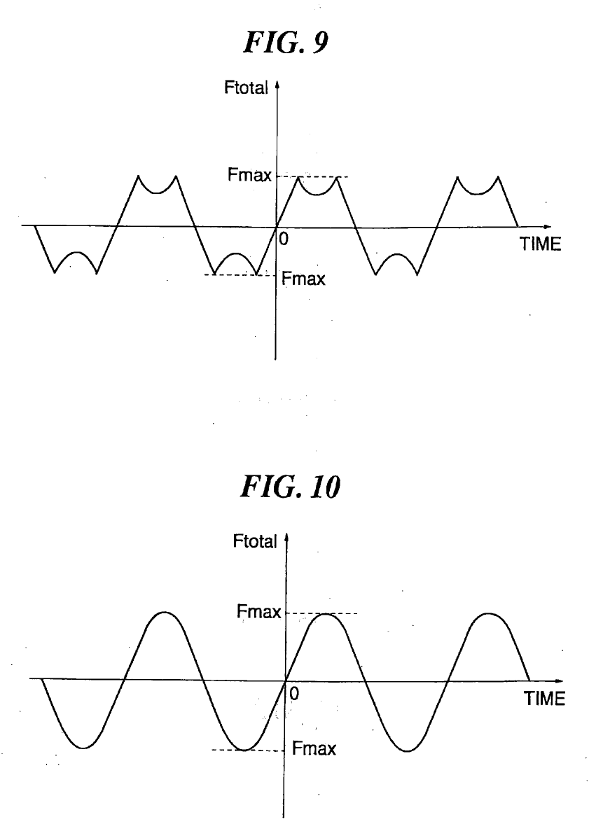

The following description uses parameters which are the same as those used for the description of the prior art electrostatic speaker with reference to FIGS. 6-10. In this embodiment, the electrostatic force Fₘ acting on the diaphragm 10 displaced by x is represented by the equation (1) as in the case of the prior art electrostatic speaker. More accurately, it is preferable that the displacement of the center of the diaphragm 10 be defined as the displacement x of the diaphragm since the diaphragm 10 is flexible. In a case where the displacement x of the diaphragm 10 is sufficiently smaller than the distance d between the electrode 21 or 22 and the diaphragm 10, the equation (2) is substantially fulfilled. On the other hand, a restorative force Fₛ generated in the diaphragm 10, which is caused by the displacement x of the diaphragm 10, the elastic characteristic of the diaphragm 10, and the way of connection between the diaphragm and the chassis, is represented by equation (3). In this embodiment, when the diaphragm 10 is displaced by x, the elastic member 30 disposed on the side to which the diaphragm 10 is displaced is also deformed in the direction perpendicular to the electrodes, and a force to restore the deformation or strain is exerted on the diaphragm 10. A force Fₛₑ received by the diaphragm 10 from the elastic member 30 is represented as a function of the strain x by the following equation (5).

Fₛₑ=−B(8x³)/d⁵ (5)

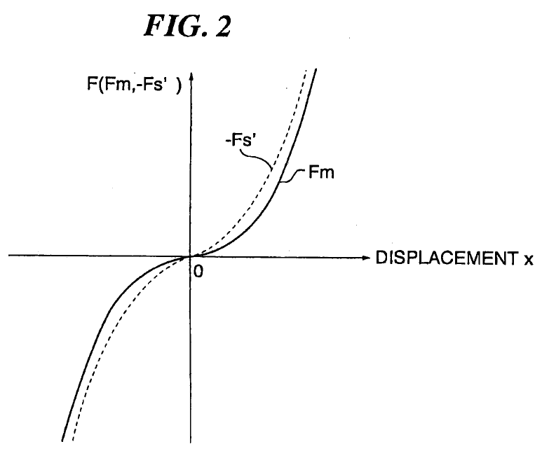

FIG. 2 shows the sum Fₛ′ of Fₛ and Fₛₑ in comparison with the electrostatic force Fₘ.

The sum F′ₜₒₜₐₗ of forces acting on the diaphragm 10 of the electrostatic speaker 1 is represented by the following equation (6).

Fₜₒₜₐₗ=Fₘ+Fₛ′=Fₘ+Fₛ+Fₛₑ=(−A+4B/d³)x (6)

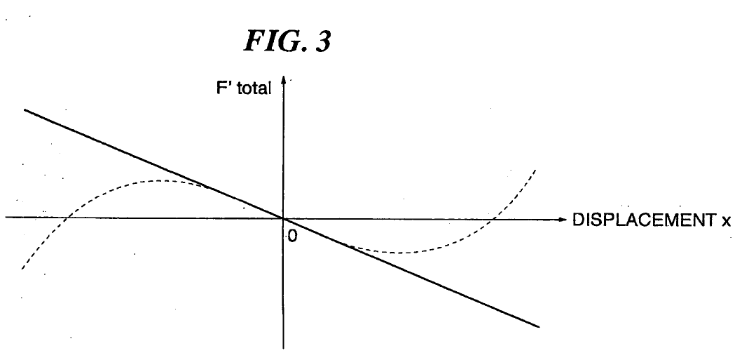

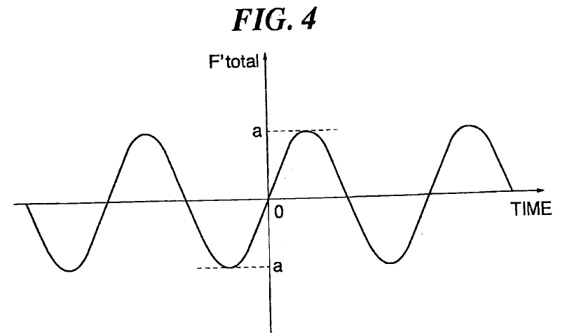

FIG. 3 is a graph showing a relationship between F′ₜₒₜₐₗ and displacement x, in which a solid line represents the F′ₜₒₜₐₗ-x curve of the present embodiment, whereas a dashed line represents that of the prior art. As will be easily understood from FIG. 3, the magnitude of the restorative force acting on the diaphragm 10 is in proportion to the displacement. FIG. 4 is a graph showing a time-dependent change of the force F′ₜₒₜₐₗ acting on the diaphragm 10 when the diaphragm 10 is in vibration.

As described above, since the restorative force acting on the diaphragm 10 can be regarded as being linear in this embodiment, the linearity of F′ₜₒₜₐₗ is not lost if the diaphragm 10 is in a position sufficiently away from the origin, i.e., even if the amplitude of the diaphragm 10 is considerably large. As a result, it is possible for the diaphragm 10 to make an ideal vibration. In other words, as compared with the prior art electrostatic speaker, a displacement range is expanded in which the linearity of the force acting on the diaphragm 10 is kept maintained, whereby both the sound pressure and sound quality can be improved simultaneously.

The following is an explanation of a method of constructing the elastic members 30 having the aforesaid elastic characteristic. In the present invention, the elastic members 30 may be constructed using a single material having an elastic characteristic represented by the equation (5). Without using such a single material having the above described characteristic, the elastic members 30 having the aforesaid elastic characteristic may be formed by various methods. The present invention is not limited in term of a method of fabricating and processing the elastic members 30. For example, the elastic members 30 may be formed by a composite material. Specifically, it is possible to obtain the above described elastic characteristic as a whole by joining a plurality of elastic members having a known elastic characteristic into one piece. In particular, in the case of using an arrangement formed by a single material not having the above described elastic characteristic, that elastic characteristic can be realized by fixing the elastic members 30 between the diaphragm 10 and the electrodes 21, 22 while applying a predetermined preload thereto when the elastic members are interposed between the diaphragm and the electrodes. In the following, the just-mentioned technique will be described.

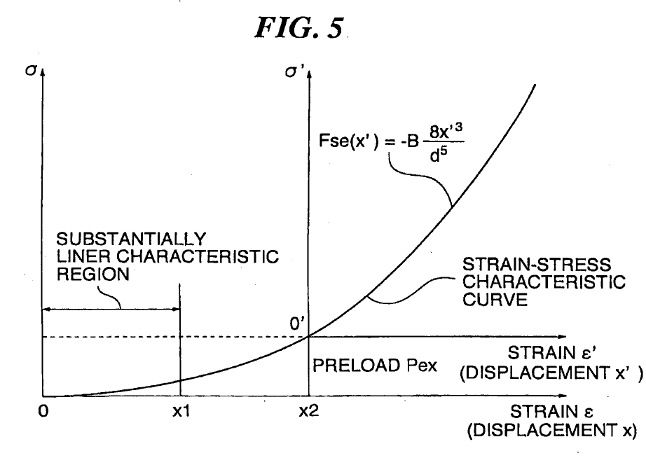

FIG. 5 exemplarily shows the elastic characteristic of the elastic members 30 applied with no preload, using a strain(ε)-stress(σ) curve. As shown in FIG. 5, in an ordinary state, the elastic members 30 each have a substantially linear elastic characteristic in a region (0<x<x1) in which the strain is small. On the other hand, a non-linearity appears, if the strain becomes large. Thus, the characteristic as shown in the equation (5) cannot be realized, if the elastic members 30 are fixed between the electrodes 21, 22 and the diaphragm 10 in an ordinary state, i.e., for example, without being applied with a pressure in advance.

In this embodiment, therefore, elastic members each having an elastic characteristic as shown in FIG. 5 are employed in a region in which a desired condition is satisfied. Specifically, the elastic members 30 are fixed in a state applied with a preload Pₑₓ corresponding to the above described elastic characteristic. A value of the preload Pₑₓ can be determined by calculating the origin of such a region where predetermined similarity is satisfied when σ(ε) is approximated to qε³, wherein q is a constant. The above is equivalent to shift the origin of the coordinate system (ε−σ) from O to O′ by x₂ to thereby realize the desired elastic characteristic in the resultant coordinate system (ε′-σ′). More specifically, elastic members each having a thickness of d+x₂ are prepared and forcibly fitted within spaces (distance d) between the electrodes 21, 22 and the diaphragm 10.

This embodiment is characterized in that it uses the elastic members 30 each having the elastic characteristic that cancels the term of the third order of the electrostatic force Fₘ as shown in the equation (5). It should be noted that the elastic characteristic is not limited to one shown in the equation (5). For example, the elastic characteristic may include a term of the first order as shown by the following equation (7) where C is a constant.

Fₛₑ=−B(8x³)/d⁵−Cx (7)

Even in this case, it is apparent that the linearity of the force F′ₜₒₜₐₗ is not affected. The elastic characteristic of the elastic members 30 may further include a term for canceling terms of higher order (terms of the fifth order or higher orders) in the equation (2).

In this invention, it is not inevitably necessary to strictly mathematically satisfy the equation (5). In essence, the aforementioned advantages can be attained, if the elastic members have such an elastic characteristic that substantially cancels non-linear terms of the electrostatic force Fₘ represented by the equation (1) so that the non-linearity of the restorative force acting on the diaphragm is made substantially negligible. In the above described embodiment, only the force applied from the elastic member on the side to which the diaphragm 10 is displaced is considered as Fₛₑ. If the force (exerting in the direction opposite from the direction in which the restorative force is exerted) generated by the elastic member 30 on the opposite side and acting on the diaphragm 10 when the diaphragm is displaced is considered, the non-linear terms of the electrostatic force Fₘ can be canceled more accurately. A value of a proportionality coefficient 8B/d⁵ can be made coincide with or approximate to a proportionality coefficient in the elastic characteristic by adjusting B relating to an applied voltage value and/or a value of the distance d relating to the speaker thickness, at least so long as the linear elastic characteristic of the elastic members 30 is proportional to or substantially proportional to the cube power of the strain, even if the linear elastic characteristic of the elastic member 30 does not satisfy the equation (5) in a strict sense.

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

What is claimed is:

1. An electrostatic speaker comprising:
a pair of opposed electrodes;
a diaphragm disposed between said opposed electrodes so as to be able to be displaced by an elastic force; and
elastic members having a linear elastic characteristic that generates a restorative force proportional to a cube power of a strain in a direction in which said diaphragm is displaced, said elastic members being interposed between said diaphragm and respective ones of the opposed electrodes.

2. The electrostatic speaker according to claim 1, wherein said linear elastic characteristic further includes a contribution that is proportional to a first power of the strain.

3. The electrostatic speaker according to claim 1, wherein in a case where a distance between said diaphragm in a non-displaced state and one of said opposed electrodes is represented by d, displacement of said diaphragm is represented by x, B is a positive constant, and an electrostatic force Fₘ acting on said diaphragm is represented by an equation of Fₘ=B(1/(d−x)²)−B(1/(d+x)²), then the restorative force Fₛ represented by an equation of Fₛ=−Bx³/d⁵ is generated.

4. The electrostatic speaker according to claim 1, wherein said elastic members are each fixed in a state applied with a predetermined preload so as to realize the linear elastic characteristic.

5. The electrostatic speaker according to claim 1, wherein said elastic members are each comprised of a plurality of elastic members joined together.
